(19) United States
(12) Patent Application Publication
(10) Pub. No.: US 2018/0101280 A1
(43) Pub. Date: Apr. 12, 2018

(54) DISPLAYING UI COMPONENTS

(71) Applicant: International Business Machines Corporation, Armonk, NY (US)

(72) Inventors: Chikao Imade, Tokorozawa Saitama (JP); Eisuke Kanzaki, Kanagawa-ken (JP); Kouichiro Morinaka, Yokohama (JP); Kenichiro Watanabe, Yokohama (JP)

(21) Appl. No.: 15/838,400

(22) Filed: Dec. 12, 2017

Related U.S. Application Data
(63) Continuation of application No. 15/195,003, filed on Jun. 28, 2016.

(51) Int. Cl. G06F 3/0481; G06F 3/0484; G06F 3/0482; G06F 3/0483

(52) U.S. Cl. CPC G06F 3/0481; G06F 3/04842; G06F 3/0483; G06F 3/0482; G06F 3/04817

(57) ABSTRACT

An apparatus includes: a component controller displaying a balloon component in a display area, the balloon component corresponding to a window component displayed in the display area, the balloon component and the window component being to be selected by a user; and a dynamic controller changing a behavior of the balloon component on the basis of an environmental attribute. A corresponding computer-implemented method and computer program product are also disclosed.

### BACKGROUND OF THE INVENTION

The present invention relates to displaying user interface (UI) components, more specifically, to displaying UI components moving in a display area based on an attribute of the display area.

Currently, many personal computers apply a window system. In the window system, users can do multiple tasks simultaneously while maintaining multiple windows on a display and switching the windows using an input device such as a mouse or a keyboard. To simplify window control, a tabbed document interface (TDI) application may be used. A TDI application collectively controls multiple child windows with tabs under a single parent window.

### SUMMARY

According to an embodiment of the present invention, there is provided an apparatus including a component controller and a dynamic controller. The component controller displays a balloon component in a display area. The balloon component corresponds to a window component displayed in the display area. The balloon component and the window component are to be selected by a user. The dynamic controller changes a behavior of the balloon component on the basis of an environmental attribute.

According to another embodiment of the present invention, there is provided a computer-implemented method for displaying icons. The method displays, on a display area, a window including a first icon. The method receives, from a user, a display request to display a second icon corresponding to the first icon. The second icon enables the user to select the first icon. The second icon is visually different from the first icon. The method displays, in response to the display request, the second icon on the display area.

According to still another embodiment of the present invention, there is provided a computer program product for displaying components. The computer program product includes a computer readable storage medium having program instructions embodied therewith. The program instructions are executable by a computer to cause the computer to display a balloon component in a display area. The balloon component corresponds to a window component displayed in the display area. The balloon component and the window component are to be selected by a user. The program instructions are executable by a computer to further cause the computer to change a behavior of the balloon component on the basis of an environmental attribute.

### BRIEF DESCRIPTION OF THE DRAWINGS

FIG. 1A depicts application windows displayed on a display;

FIG. 1B depicts the application windows with balloons;

FIG. 2 is a block diagram of the computer system according to the exemplary embodiment of the present invention;

FIG. 3A is a block diagram of the extractor controller according to the exemplary embodiment of the present invention;

FIG. 3B is a block diagram of the conditioner according to the exemplary embodiment of the present invention;

FIG. 3C is a block diagram of the effect controller according to the exemplary embodiment of the present invention;

FIG. 4 depicts an example of the hardware configuration of the computer system able to implement this exemplary embodiment;

FIG. 5 is a flowchart of the setup operation of the UI components controller according to the exemplary embodiment;

FIG. 6 is a flowchart of the extract operation of the UI components controller according to the exemplary embodiment;

FIG. 7 is a flowchart of the access operation of the UI components controller according to the exemplary embodiment;

FIG. 8A depicts a parameter setting window for the extract operation according to the exemplary embodiment;

FIG. 8B depicts an example of the position and the direction of the fan according to the exemplary embodiment;

FIGS. 9A and 9B depict examples of the function of the balloons;

FIGS. 10A and 10B depict examples of the setting of the fan; and

FIGS. 11A to 11D depict other examples of the balloon.

### DETAILED DESCRIPTION

Currently available techniques exemplary embodiments of the present invention will be described in detail with reference to the attached drawings.

It is to be noted that the present invention is not limited to these exemplary embodiments to be given below and may be implemented with various modifications within the scope of the present invention. In addition, the drawings used herein are for purposes of illustration, and may not show actual dimensions.

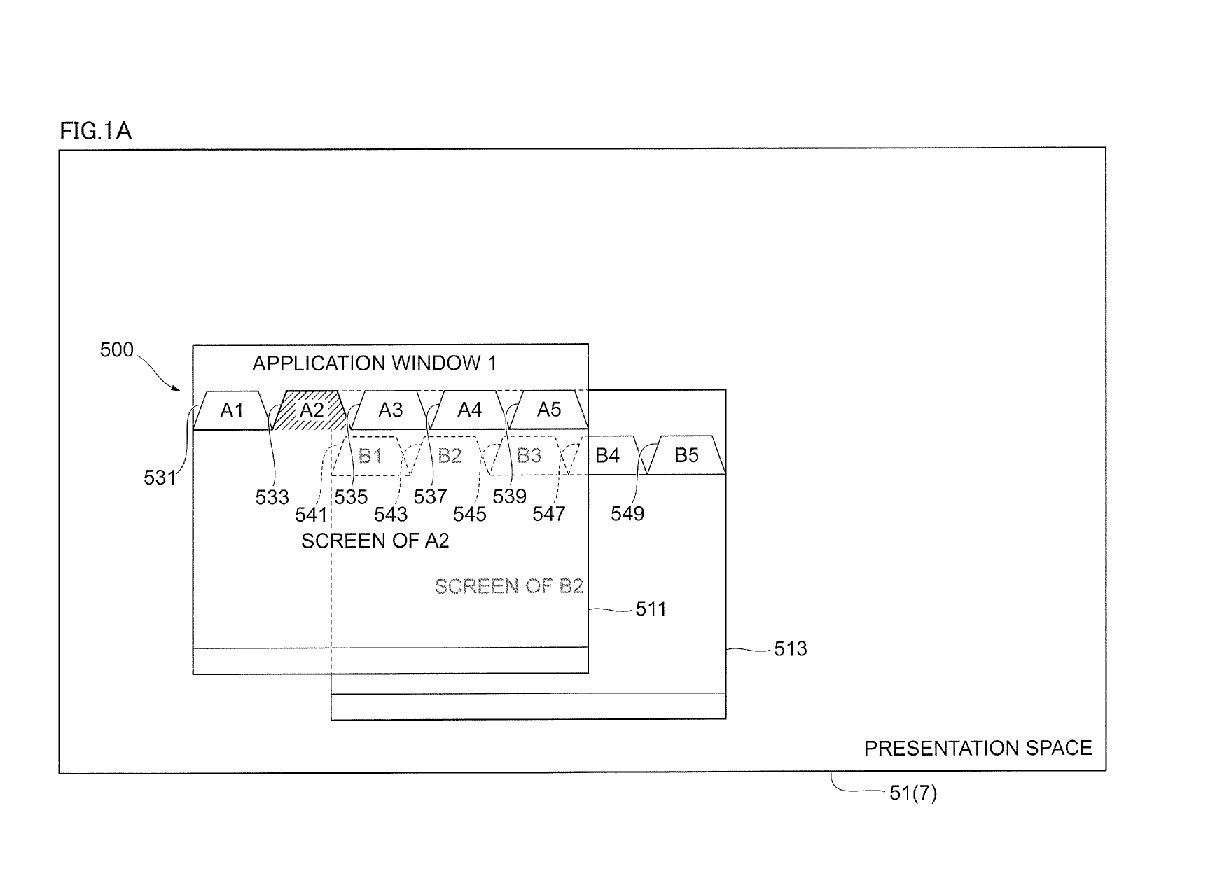

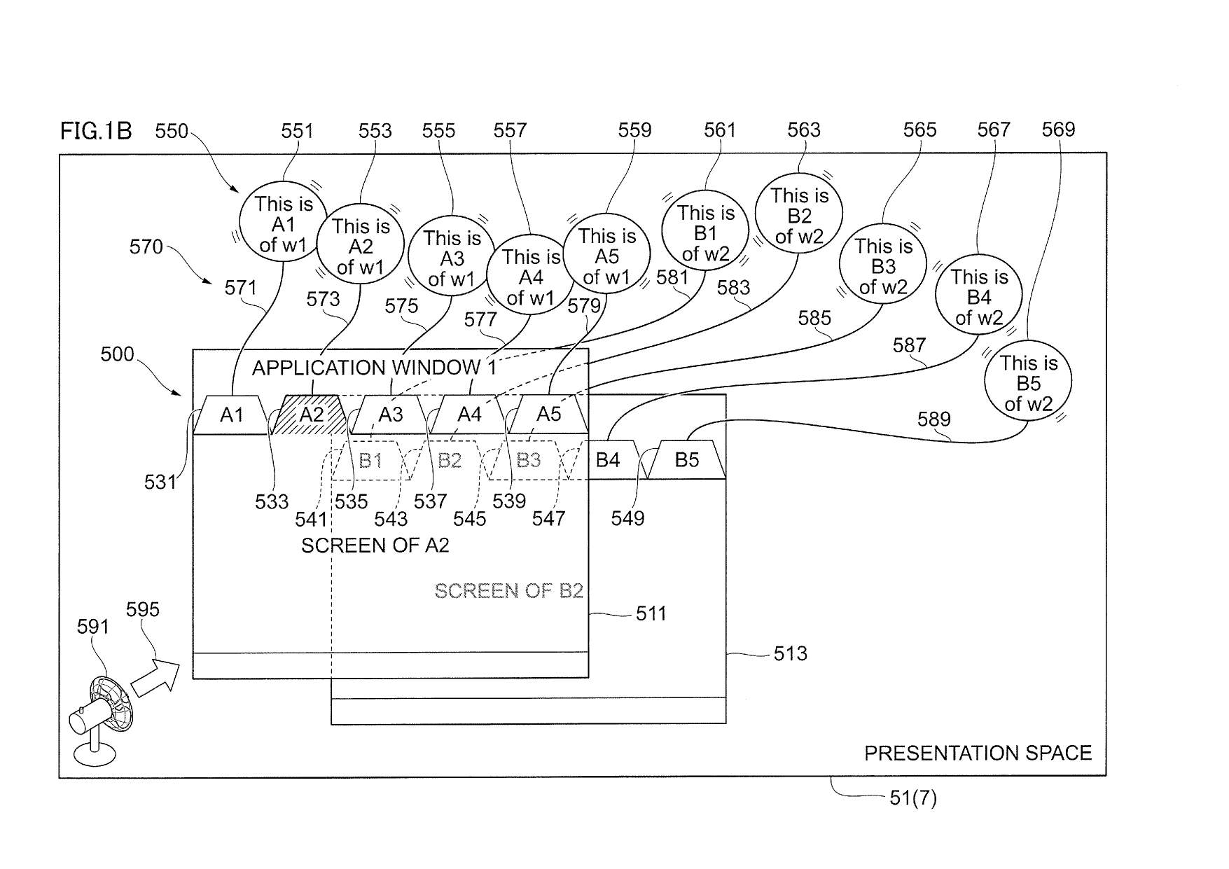

FIG. 1A depicts application windows 511 and 513 displayed on a display 7, and FIG. 1B depicts the application windows 511 and 513 with balloons 550. As shown in FIGS. 1A and 1B, the application windows 511 and 513 are displayed in a presentation space (display area) 51 on the display 7. The presentation space 51 may be a desktop included in a computer system 1 (described later), for example. The application window 511 includes multiple child windows (panels or screens) tabbed with the first tab 531 to the fifth tab 539, respectively. The application window 513 also includes multiple child windows (panels) tabbed with the sixth tab 541 to the tenth tab 549, respectively. The first tab 531 to the tenth tab 549 (hereinafter may be referred to as “tabs 500”) each include a text for identifying the corresponding panel. For example, the second tab 533 includes a title of the corresponding panel, namely “A2.” Note that the text is an example of identifying information.

If a user selects one of the tabs 500, the corresponding panel is displayed in the application window 511 or 513. For example, if the user selects the second tab 533, the panel of A2 appears as shown in FIG. 1A. Here, each of the tabs 500 serves as a selectable user interface (UI) component. It is to be noted that the selectable UI component is not limited to this form, and any graphical user interface (GUI) is applicable. For example, the selectable UI component may be a button, a pull down menu, a tree view, or a list view in the panel.

The applications displaying the application windows 511 and 513 in the presentation space 51 may be any application, such as a web browser, a document creation application, a spread sheet application, a database application, or a presentation application. In this exemplary embodiment, the applications displaying the application windows 511 and 513 are assumed to be the same application, but different applications may display the application windows 511 and 513, respectively. The contents within the panels displayed in the application windows 511 and 513 may be any contents such as a web page, an e-mail, a document, a spread sheet, a slide, a memo, or an address book.

If the number of the tabs 500 in the application windows 511 and 513 increases, accessibility to each of the tabs 500 may be decreased. For example, it may take a longer time for the user to find a particular tab. Also, the size of each of the tabs 500 becomes small so that the space for the text such as the title becomes limited.

As shown in FIG. 1A, since the application window 511 covers a part of the application window 513, the user cannot directly press (select) the sixth tab 541, the seventh tab 543, and the eighth tab 545 that reside in the covered part.

To improve accessibility to the tabs 500, this exemplary embodiment displays other selectable UI components i.e. balloons 550 in the presentation space 51, as shown in FIG. 1B. More specifically, this embodiment defines the presentation space 51 as a three dimensional (3D) virtual space, and extracts (screens out) the selectable UI components (the tabs 500) from the two-dimensional application windows 511 and 513, and displays the balloons 550 corresponding to the extracted tabs 500 in the 3D virtual space. The balloons 550 are visually different from the tabs 500.

The presentation space 51, as defined as the 3D virtual space, has a 3D coordinate. That is to say, a distant object in the presentation space 51 is displayed small, while a nearby object is displayed large. Further, the 3D virtual space is assumed as in the atmosphere. Accordingly, if the user places a fan 591 (a function tool for the extraction; described later), a virtual wind (indicated by an arrow 595 in FIG. 1B) is generated in the presentation space 51 to screen out the tabs 500. More specifically, the tabs 500 react to the wind to display the balloons 550 flowing out from the tabs 500 in the wind direction.

The balloons 550 correspond to the tabs 500, respectively. In FIG. 1B, the balloons 550 include a balloon 551 to a balloon 569. The balloons 550 and the tabs 500 are tied with strings 570, i.e. a string 571 to a string 589. The balloons 550 show information for identifying the corresponding one of the tabs 500. For example, the balloon 553 includes the text “This is A2 of w1.” Here, “w1” stands for the application window 511. That is to say, the text indicates that the balloon 553 is tied to the second tab 533 of the application window 511.

The balloons 550 have a function for allowing easy access to a target panel. More specifically, if the user selects one of the balloons 550, the panel (part) tabbed with the corresponding one of the tabs 500 reacts in a selected way. For example, if the user points, e.g. clicks one of the balloons 550, the corresponding panel or the window comes frontward in the 3D virtual space. More specifically, if the user selects the balloon 553 tied to the second tab 533, the panel tabbed with the second tab 533 is displayed in the application window 511. That is to say, the balloons 550 and the tabs 500 have a similar function to switch the panels by selecting them. The panels are examples of the same image in the display area. Further, if the user grabs, e.g. drags one of the balloons 550, the corresponding panel or the window may be pulled frontward. Also, if the user grabs and enlarges e.g. pinches out one of the balloons 550, the corresponding panel or the window may be enlarged.

The balloons 550 may slightly move (sway) in the 3D virtual space. In other words, behavior of the balloons 550 changes in the 3D virtual space. Behavior includes any motion of the balloons 550 (first components or balloon components), such as sway, rotation, swell or spin. This enables the user to view all of the balloons 550 if the user waits for a predetermined time period. For example, while the balloon 553 overlaps the balloon 551 in FIG. 1B, the balloon 551 may later come in front of the balloon 553 with the sway motion. That is to say, the user can have a moment to view the entire object of each of the balloons 550. In this exemplary embodiment, all texts shown in the balloons 550 can be displayed in the selected time period.

Further, as shown in FIG. 1B, the balloons 550 are always displayed foremost, and do not overlap the application windows 511 and 513. In other words, the location of the balloons 550 is outside of the windows 511 and 513. However, the balloons 550 may be on any other location, and may overlap the application windows 511 and 513, for example. Note that the balloons 550 are examples of a balloon component and a second icon. The tabs 500 are examples of a window component (or a second component) and a first icon. Both component and icon are a selectable UI displayed in the display 7.

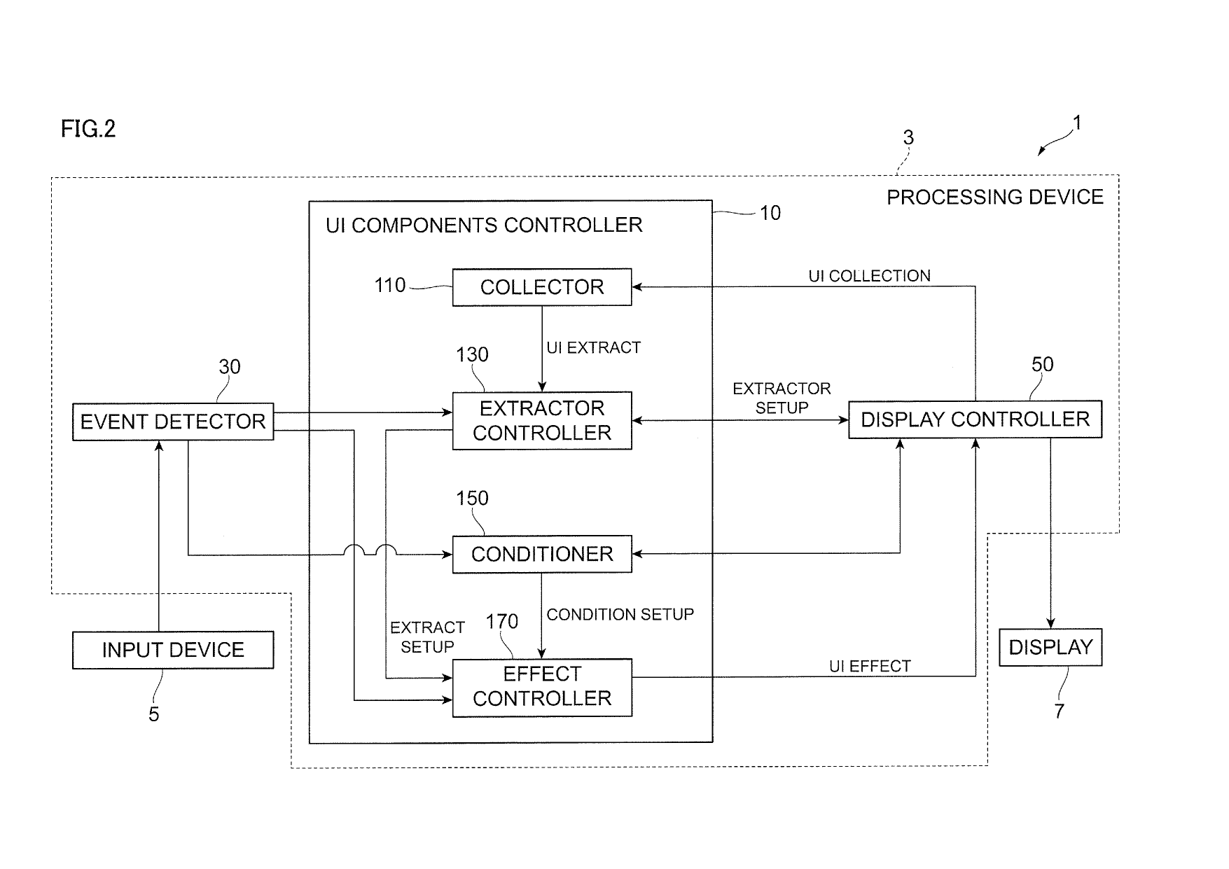

FIG. 2 is a block diagram of the computer system 1 according to the exemplary embodiment of the present invention. As shown in FIG. 2, the computer system 1 may include a processing device 3, an input device 5, and a display 7.

The processing device 3 may include a UI components controller 10, an event detector 30, and a display controller 50. The UI components controller 10 performs a selected process to control the UI components displayed in the display 7. The event detector 30 detects an event, i.e. receives an input from the input device 5 such as a mouse or a keyboard, and outputs the input data to the UI components controller 10. The display controller 50 communicates with the UI components controller 10 and controls the display 7. The event detector 30 is an example of a receiver.

The UI components controller 10 may include a collector 110, an extractor controller 130, a conditioner 150, and an effect controller 170. Note that the conditioner 150 is an example of a dynamic controller. The effect controller 170 is an example of a component controller. The extractor controller 130 and the effect controller 170 are examples of a switch.

The collector 110 collects and stores UI components information. The UI components information is information on the attribute of the UI components (e.g. the tabs 500 in FIGS. 1A and 1B) shown in the display 7. The collector 110 dynamically obtains the UI components information and updates the attribute of the UI components. The attribute of the UI components is an example of information on the window component.

The attribute of the UI components may include appearance condition and usage condition of the UI components. The appearance condition may include the position of the UI components in the presentation space 51, the size of the UI components, and the color of the UI components. The usage condition of the UI components may include a frequency of use of each UI component, and a time when each UI component was used last.

The extractor controller 130 screens out or extracts the UI components information from the collector 110. The extractor controller 130 receives an input of parameters of the extraction (described later) via the event detector 30. Based on the received input, the extractor controller 130 calculates the parameters of the extraction and outputs the parameter data to the display controller 50 and the effect controller 170. The extractor controller 130 extracts the UI components dynamically and outputs the updated data. For example, the extractor controller 130 outputs an extractor setup. In other words, the extractor controller 130 outputs the data of the position of the fan 591 in the presentation space 51 (refer to FIG. 1B). Note that the fan 591 is a GUI for the extractor, and an example of an image. In this exemplary embodiment, the fan 591 is the GUI to set and display a direction (the arrow 595 in FIG. 1B for example) of the wind generated in the presentation space 51.

The conditioner 150 defines the presentation space 51. The conditioner 150 receives an input of parameters (definition) of the presentation space 51 via the event detector 30. Based on the received input, the conditioner 150 calculates the parameters of the presentation space 51 and outputs the parameter data to the display controller 50. In this exemplary embodiment, the conditioner 150 defines the presentation space 51 as the 3D virtual space with the atmosphere. As mentioned above, wind can blow in this 3D virtual space. That is to say, the atmosphere in the 3D virtual space can move in a predetermined direction. Here, the conditioner 150 may receive the input of the parameters of the 3D virtual space such as width, height, and depth of the 3D virtual space, and barometric pressure via the event detector 30.

The effect controller 170 sets the UI effects, i.e. the balloons 550 (refer to FIG. 1B). The effect controller 170 receives an input of parameters of the UI effects via the event detector 30. Based on the received input, the effect controller 170 calculates the parameters of the UI effects and outputs the parameter data to the display controller 50.

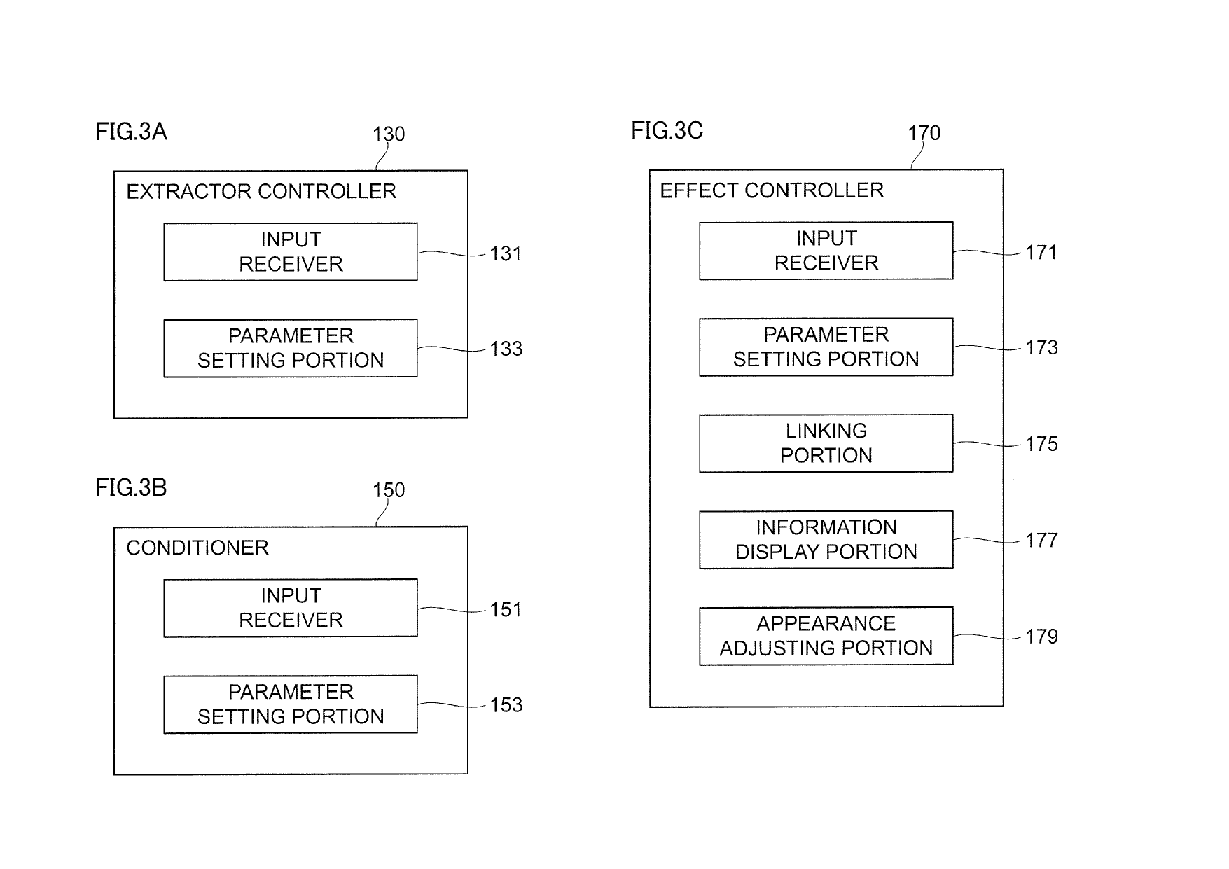

FIG. 3A is a block diagram of the extractor controller 130 according to the exemplary embodiment of the present invention. As shown in FIG. 3A, the extractor controller 130 may include an input receiver 131 and a parameter setting portion 133. The input receiver 131 extracts the UI components information, and the parameter setting portion 133 calculates the parameters.

FIG. 3B is a block diagram of the conditioner 150 according to the exemplary embodiment of the present invention. As shown in FIG. 3B, the conditioner 150 may include an input receiver 151 and a parameter setting portion 153. The input receiver 151 receives the input of the parameters of the 3D virtual space, and the parameter setting portion 153 calculates the parameters.

FIG. 3C is a block diagram of the effect controller 170 according to the exemplary embodiment of the present invention. As shown in FIG. 3C, the effect controller 170 may include an input receiver 171, a parameter setting portion 173, a linking portion 175, an information display portion 177, and an appearance adjusting portion 179. The input receiver 171 receives the input of the parameters of the UI effects, and the parameter setting portion 173 calculates the parameters.

The linking portion 175 determines which one of the balloons 550 is to be tied to which one of the UI components (the tabs 500) with the strings 570. The linking portion 175 also determines the shape of the strings 570.

The information display portion 177 determines the information shown in the balloons 550. The information to be shown may include the text indicating one of the tabs 500 to which one of the balloons 550 is tied. Depending on the size of the balloons 550, the information display portion 177 may adjust the size or the number of the characters shown in the balloons 550.

The appearance adjusting portion 179 determines the appearance of the balloons 550, such as a shape or a color. Depending on the attribute of the tabs 500, the appearance adjusting portion 179 may adjust the appearance of the balloons 550.

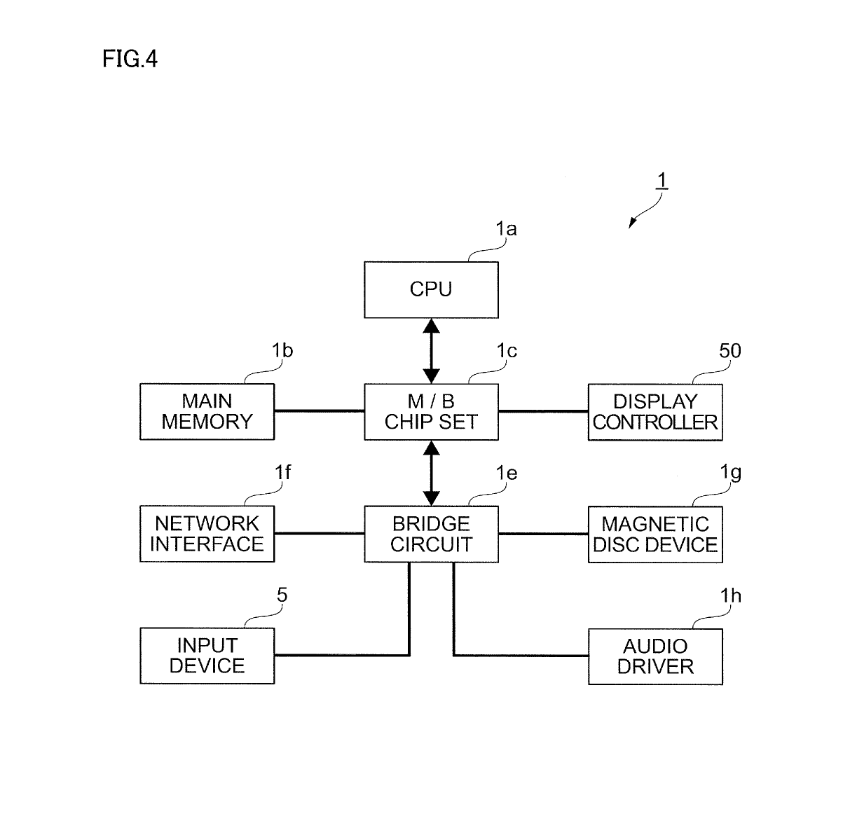

FIG. 4 depicts an example of the hardware configuration of the computer system 1 able to implement this exemplary embodiment. As shown in FIG. 4, the computer system 1 may include a central processing unit (CPU) 1a serving as a computing unit, a main memory 1b connected to the CPU 1a via a motherboard (M/B) chip set 1c and serving as one example of a memory, and the display controller 50 connected to the CPU 1a via the same M/B chip set 1c. A network interface 1f, a magnetic disk device (HDD) 1g, an audio driver 1h, and the input device 5 are also connected to the M/B chip set 1c via a bridge circuit 1e.

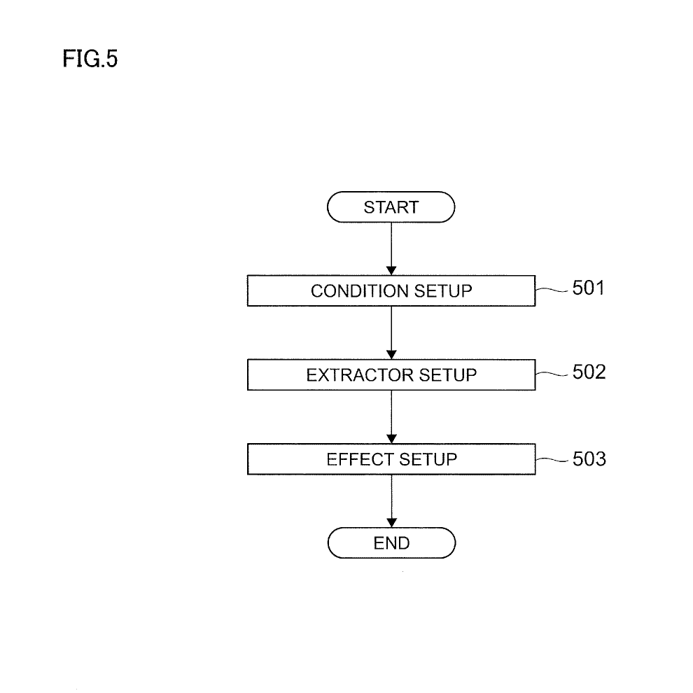

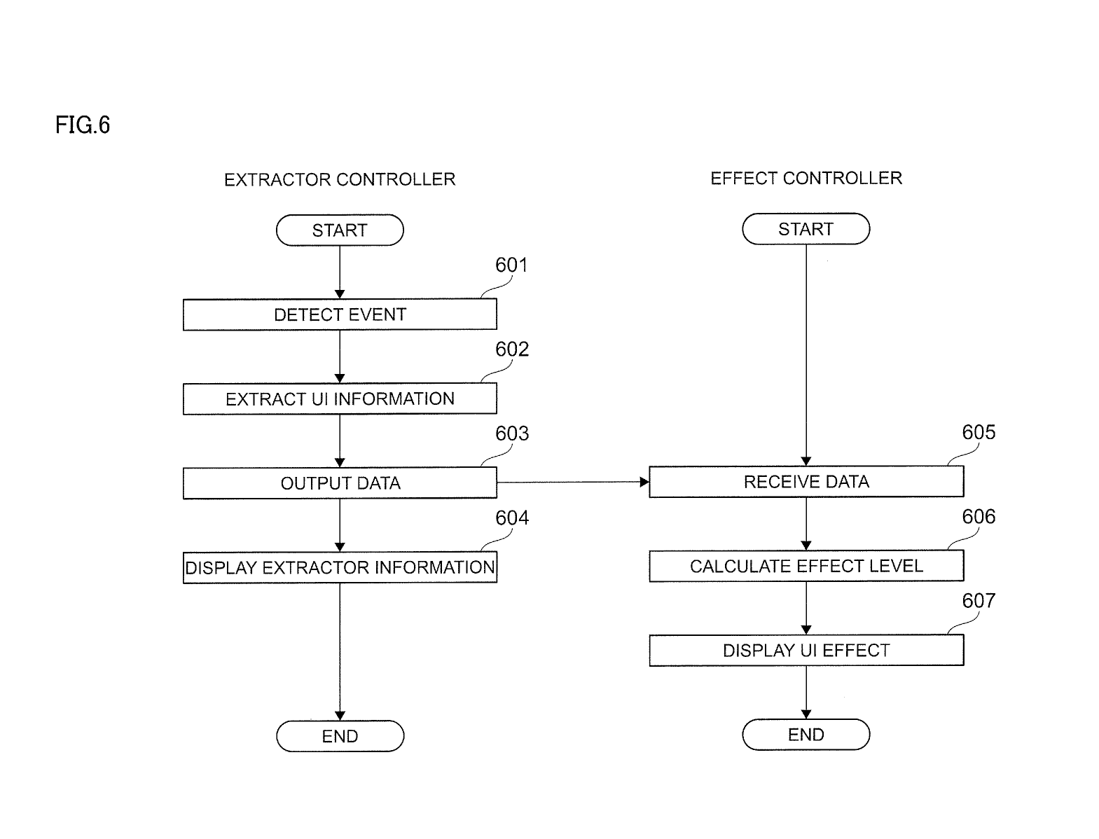

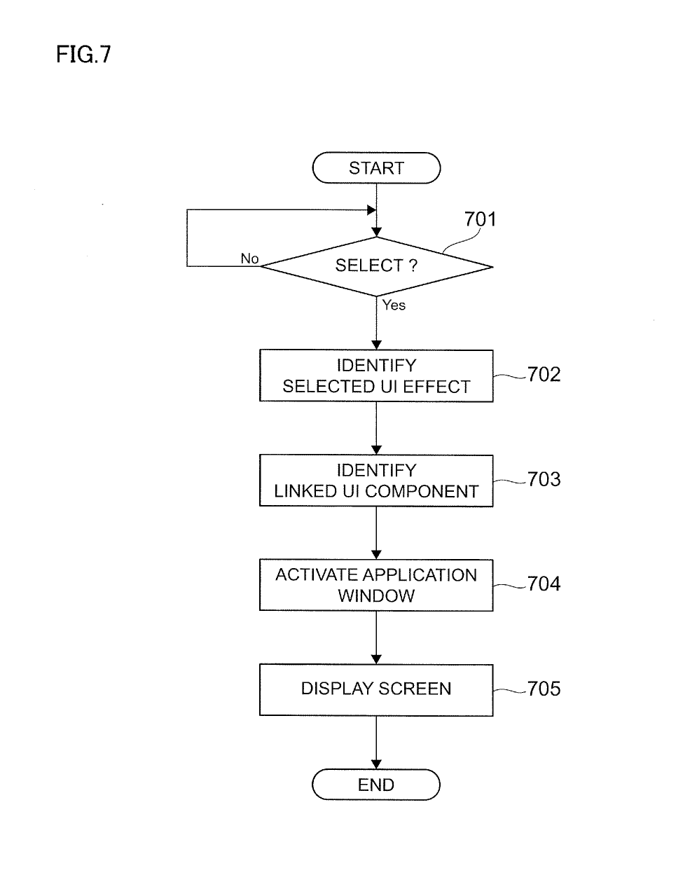

FIG. 5 is a flowchart of the setup operation of the UI components controller 10 according to the exemplary embodiment. FIG. 6 is a flowchart of the extract operation of the UI components controller 10 according to the exemplary embodiment. FIG. 7 is a flowchart of the access operation of the UI components controller 10 according to the exemplary embodiment.

Referring to FIGS. 5 to 7, the operation of the UI components controller 10 according to the exemplary embodiment will be described. The UI components controller 10 may perform the setup operation, the extract operation, and the access operation.

The setup operation is configured to set up the UI components controller 10. More specifically, the extractor controller 130, the conditioner 150, and the effect controller 170 of the UI components controller 10 perform the setup operation, for example, when the computer system 1 is activated.

As shown in the FIG. 5, the parameter setting portion 153 of the conditioner 150 performs the setup operation. In one embodiment, the parameter setting portion 153 of the conditioner 150 sets the parameters of the condition of the presentation space 51 (step 501). The parameter setting portion 133 of the extractor controller 130 performs the setup operation. In one embodiment, the parameter setting portion 133 of the extractor controller 130 sets the parameters of the extractor (step 502). The parameter setting portion 173 of the effect controller 170 performs the setup operation. In one embodiment, the parameter setting portion 173 of the effect controller 170 sets the parameters of the UI effects (step 503).

The extract operation is configured to extract the UI components information to display the UI effects. More specifically, the extractor controller 130 and the effect controller 170 perform the extract operation. In one embodiment, the extractor controller and the effect controller perform the extract operation when the event detector 30 detects the event, i.e. receives an input from the input device 5.

As shown in FIG. 6, if the extractor controller 130 detects the event (step 601), the extractor controller 130 extracts the UI components information from the collector 110 with the parameters of the extractor that have been set at step 502 (step 602). Then the extractor controller 130 outputs the data based on the extracted UI components information (step 603), and displays extractor information, i.e. the fan 591 in the presentation space 51 via the display controller 50 (step 604).

If the effect controller 170 receives the data from the extractor controller 130 (step 605), the effect controller 170 calculates the property (level) of the UI effects, using the parameters of the UI effects that have been set at step 503 (step 606). The effect controller 170 displays the UI effects, i.e. the balloons 550 in the presentation space 51 via the display controller 50 (step 607).

In this exemplary embodiment, the user may change the parameters of the extraction and the UI effects via the input device 5, after the balloons 550 are displayed in the presentation space 51. If the input receiver 131 of the extractor controller 130 or the input receiver 171 of the effect controller 170 detects that these parameters are changed, the extractor controller 130 and the effect controller 170 execute the above extract operation.

In this exemplary embodiment, the event detected by the extractor controller 130 at step 601 is an example of a display request to display a second icon corresponding to the first icon.

As shown in FIG. 7, if the effect controller 170 receives an input to select one of the UI effects, i.e. the balloons 550 via the event detector 30 (step 701), the effect controller 170 identifies the selected UI effect (step 702). The effect controller 170 then identifies the corresponding UI component, i.e. one of the tabs 500 which is tied to the selected UI effect (step 703). Then the effect controller 170 activates the application window 511 or 513 including the corresponding UI component (step 704) and displays the panel of the corresponding UI component (step 705).

In this exemplary embodiment, after the panel of the corresponding UI component is displayed, the effect controller 170 hides the balloons 550. In other words, the extracting function is turned off to restore the normal application windows 511 and 513 (refer to FIG. 1A).

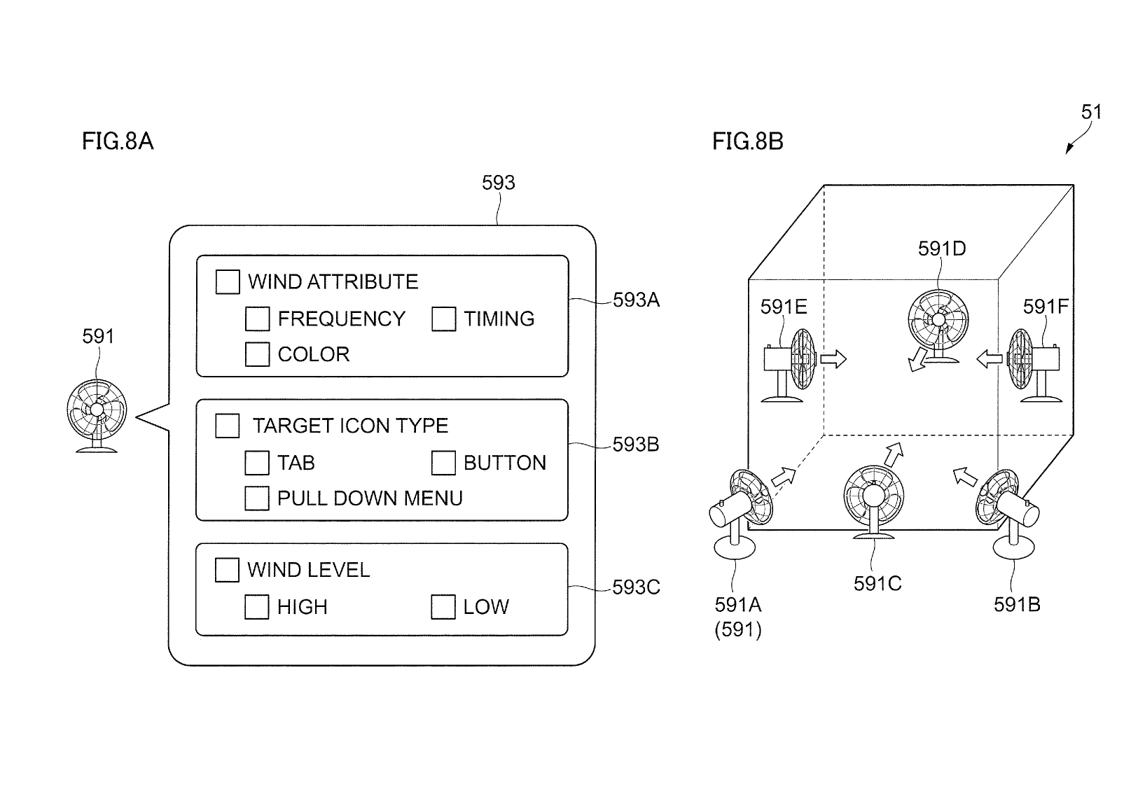

FIG. 8A depicts a parameter setting window 593 for the extract operation according to the exemplary embodiment. In this exemplary embodiment, the extractor controller 130 may screen out the UI components based on the attribute of the UI components before displaying the UI effects.

As depicted with respect to FIG. 8A, the fan 591, which is the GUI for the extractor, blows wind for screening out the UI components (the tabs 500) in the 3D virtual space. The user can modify the setting of the fan 591 such as by setting the wind type, which changes the appearance of the UI effects. Note that setting the wind type means defining the environmental attribute of the 3D virtual space.

As shown in FIG. 8A, the parameter setting window 593 can accept the input of the parameters of the wind type. The parameters may include a wind attribute, a target icon type, and a wind level. These parameters (wind attribute, target icon type and wind level) are examples of the environmental attribute of the 3D virtual space. Environmental attribute may also include gravity, weather or pressure of the atmosphere. The conditioner 150 (dynamic controller) changes the behavior of the balloons 550 on the basis of the environmental attribute.

The wind attribute (one example of the environmental attribute) is a criteria for screening by which the UI components having a corresponding attribute is to be extracted. The user can choose the wind attribute among frequency, timing and color in the sub-window 593A. The frequency is the frequency of use of the target UI component. The timing is the time when the target UI component was used last, in other words, elapsed time from the last use. The color is the displayed color of the target UI component.

The target icon type (one example of the environmental attribute) is the type of the UI components to be extracted. The user can choose the UI component type among tab, button, and pull down menu in the sub-window 593B.

The wind level (one example of the environmental attribute) is the parameter of the power of the wind, i.e. the strength of screening. The user can set the wind level at high or low in the sub-window 593C. Note that if the wind level is changed, the shape of the balloons 550 may change accordingly.

Here, the parameter setting portion 133 of the extractor controller 130 displays the window 593 for setting the parameters of the extraction if the input receiver 131 receives the input from the event detector 30. For example, the window 593 appears if the user right-clicks the fan 591 displayed in the presentation space 51. Then the user can set the above parameters, i.e. the wind attribute, the target icon type, and the wind level, in the window 593. Further, the fan 591 has a function of controlling ON and OFF of the extraction (screening) function. For example, if the user left-clicks the fan 591, the extractor controller 130 stops the extraction operation. That is to say, the balloons 550 disappear from the presentation space 51.

FIG. 8B depicts an example of the position and the direction of the fan 591 according to the exemplary embodiment. As mentioned above, the fan 591 generates the virtual wind in the 3D virtual space (the presentation space 51). As shown in the figure, the direction of the wind may change depending on the position of the fan 591 in the presentation space 51.

As shown in FIG. 8B, the fan 591 may be located in multiple positions (six positions in the figure; the fan 591A to the fan 591F) within the presentation space 51. The directions of the fan 591A and the fan 591F are different from each other, while every wind generated by the fan 591A to the fan 591F blows toward the center of the 3D virtual space, as indicated by arrows in the figure. This enables to specify the direction of the wind by selecting the position of the fan 591. For example, if the fan 591 is located at the position of the fan 591A, i.e. lower left in the space, the wind blows from the front lower left to the back upper right in the presentation space 51.

If the position of the fan 591 changes, the position of the balloon 550 changes because the balloon 550 is blown in the direction of the generated wind. Note that the fan 591 may be of any appearance; the fan 591 may take an appearance of a weathercock, a flag, a streamer, a compass, or an arrow. Besides or instead of the fan 591, tracer particles, for example cherry blossom petals, can be flown in the space for the user to visually understand the wind direction and the wind level.

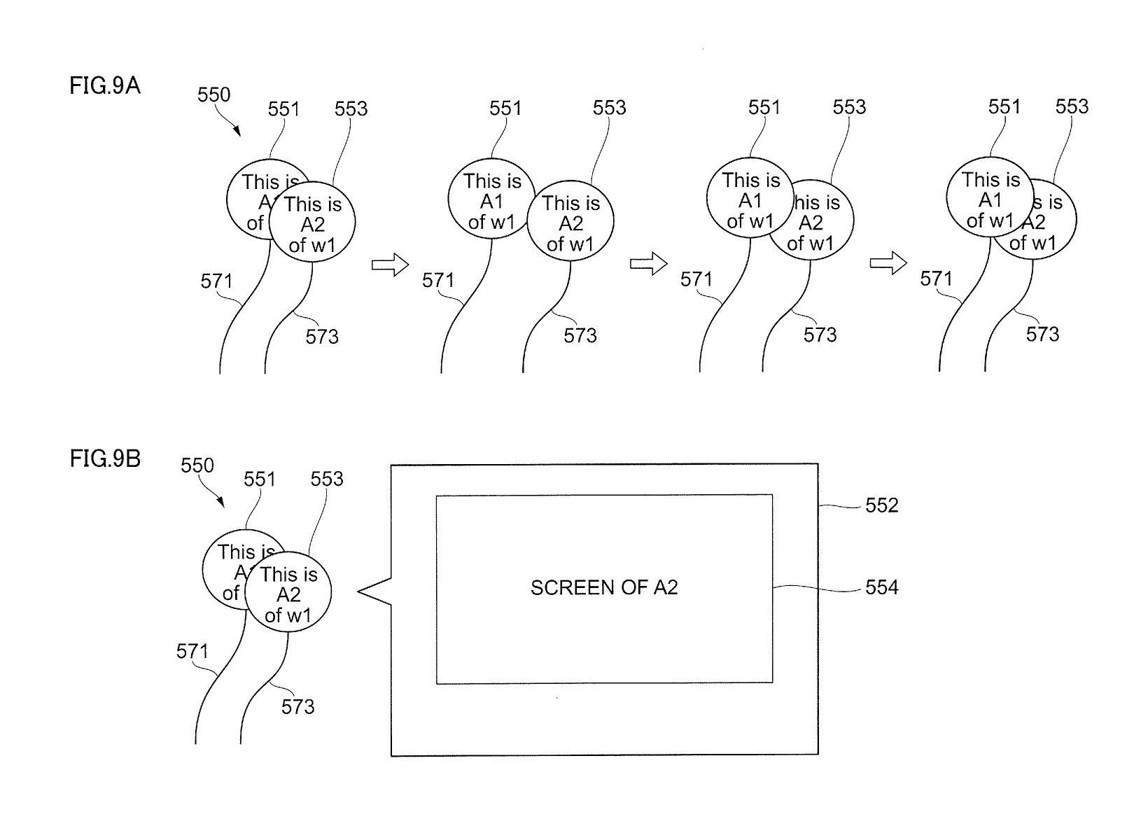

FIGS. 9A and 9B depict examples of the function of the balloons 550. Referring to FIGS. 9A and 9B, the function of the balloons 550 will be described in detail. In the figures, the balloons 551 and 553 are shown among the balloons 550.

As shown in FIG. 9A, the balloons 551 and 553 may overlap each other. The balloons 551 and 553 sway in the virtual wind in the 3D virtual space, changing their relative positions so that the overlapped portion of the balloons 551 and 553 is revealed in a certain period. Accordingly, the user may view all texts in the balloons 551 and 553 if the user waits for the certain period.

As shown in FIG. 9B, the effect controller 170 may display a preview panel 552 if the user hovers a pointer over the balloon 553. The preview panel 552 includes the corresponding panel 554, i.e. the panel of A2 in this example. This corresponding panel 554 may assist the user in selecting one of the balloons 550. Further, if the user clicks the corresponding panel 554, the panel of A2 is displayed as shown in FIG. 1A. That is to say, the balloons 550 and the corresponding panel 554 have a similar function to switch the panels by selecting them.

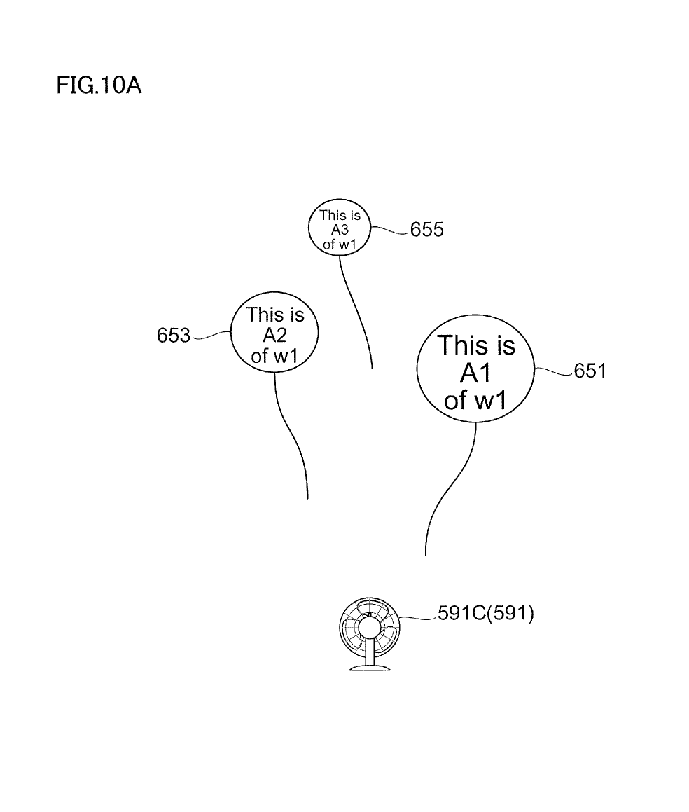

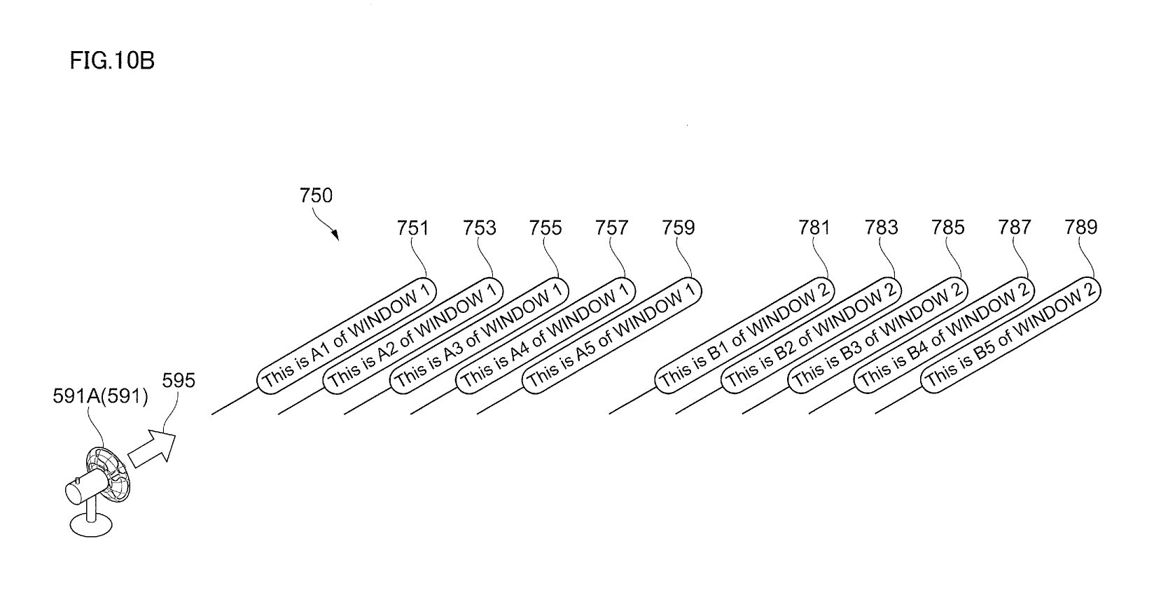

FIGS. 10A and 10B depict examples of the setting of the fan 591. Referring to FIGS. 10A and 10B, the setting of the fan 591 will be described in detail.

As mentioned above, the fan 591 blows the wind to screen out the tabs 500 based on the attribute of the tabs 500 to display the balloons 550. Depending on the attribute of the tabs 500, the appearance of the balloons 550 may change.

In FIG. 10A, the fan 591C is placed at the front side in the 3D virtual space, and generates the wind blowing from the front to the back in the space. In the figure, the fan 591C is assumed to blow the wind with the wind attribute of frequency. The position of the balloons 651, 653, 655, i.e. the depth in the 3D virtual space may change depending on the frequency of use of the corresponding one of the tabs 500. For example, the balloon 651 tied to the most frequently used tab is positioned at the front side, the balloon 653 tied to a less frequently used tab is positioned in the middle, and the balloon 655 tied to the least frequently used tab is positioned at the far side.

The displayed size of the balloons 651, 653, 655 may change depending on their depth in the 3D virtual space. For example, in FIG. 10A, the balloon 651 with the highest frequency is at the front side and shown in the largest size, the balloon 653 with a less frequency is located in the middle and shown in a smaller size, and the balloon 655 with the lowest frequency is at the far side and shown in the smallest size. Note that the size of the texts shown in the balloons 651, 653, 655 may also change depending on their depth in the 3D virtual space. In FIG. 10A, the text in the balloon 651 is displayed large, and the text in the balloon 655 is displayed small.

The appearance of the balloons 550 may change depending on the attribute of the presentation space 51, i.e. the parameters of the wind type. In other words, the balloons 550 have a functional attribute corresponding to the environmental attribute of the 3D virtual space. In this exemplary embodiment, the appearance of the balloons 550 changes depending on the setting of the fan 591. In FIG. 10B, the fan 591A is placed at the lower left in the 3D virtual space, and generates the wind blowing from the front lower left to the back upper right in the space as indicated by the arrow 595.

If the wind level of the fan 591 is set at the low level, the balloons 550 are displayed in a substantially round shape, blown by a breeze and swaying back and forth and side to side (refer to FIG. 1B). On the other hand, if the wind level of the fan 591A is set at the high level, balloons 750 (a balloon 751 to a balloon 789) flow obliquely in an elongated form as shown in FIG. 10B.

The elongated balloons 750 are capable of showing more texts compared to the balloons 550 in FIG. 1B. In FIG. 10B, all of the balloons 750 are displayed in a uniform size. That is to say, the balloons 750 are displayed uniformly regardless of the attribute of tabs 500.

All balloons 750 are aligned as shown in FIG. 10B, as opposed to the balloons 550 in the FIG. 1B. However, vertical positions of the balloons 750 may be different from each other depending on the attribute of the tabs 500. For example, one of the balloons 750 tied to a frequently used tab may be displayed above the others in the space.

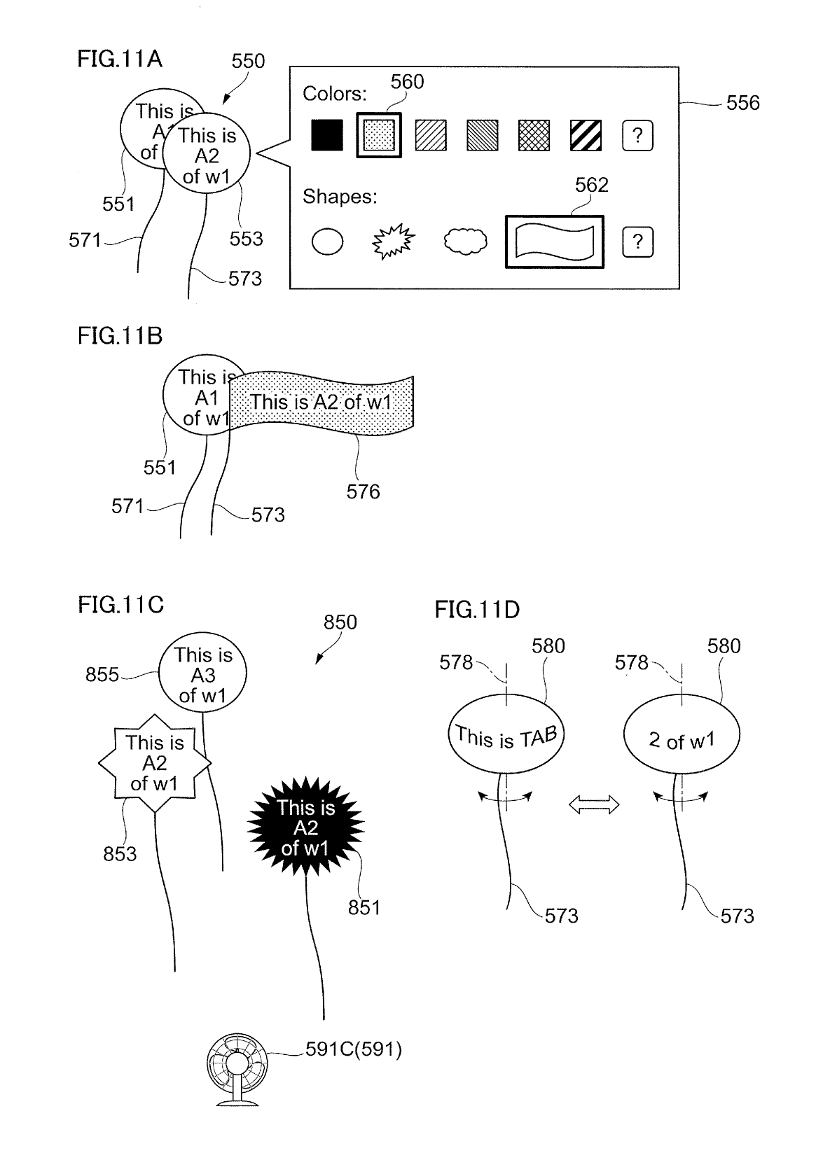

FIGS. 11A to 11D depict other examples of the balloons 550. Referring to FIGS. 11A to 11D, other examples of the balloons 550 will be described in detail.

As shown in FIGS. 11A to 11C, the appearance of the balloons 550 can be set by the user. In other words, the user can change the balloon property. This may assist the user in finding a target balloon.

As shown in FIG. 11A, the parameter setting window 556 appears if the user right-clicks the balloon 553. The parameter setting window 556 receives an input of the parameters of the balloon property. For example, the parameters of color and shape of the balloon 553 can be set in each pane in the parameter setting window 556. More specifically, if the user puts a pointer 560 on the second icon from the left in the “Colors” pane and a pointer 562 on the fourth icon from the left in the “Shapes” pane, the balloon 553 turns to a balloon 576 as shown in FIG. 11B. The balloon 576 has a shape of a streamer, which has a larger width than a round shaped balloon such as the balloon 553, so that a longer text can be shown in the balloon 576.

In FIG. 11A, question marks (?) are included in the “Colors” and the “Shapes” panes in the window 556. The question mark represents a dynamic change mode, in which the appearance of the balloon 553 changes automatically depending on the attribute of the corresponding one of the tabs 500.

FIG. 11C shows a case in which the question marks are selected in both of the “Colors” and the “Shapes” panes in the window 556. Accordingly, the colors and shapes of the balloons 850 (balloons 851, 853, 855) change automatically (dynamically) depending on how the tabs 500 are used by the user. For example, the front-side balloon 851 tied to the most frequently used tab takes a conspicuous appearance, i.e. a burred shape in red. The mid-position balloon 853 tied to a less frequently used tab takes a less conspicuous appearance, i.e. an edged shape in green. The far-side balloon 855 tied to the least frequently used tab takes an inconspicuous appearance, i.e. a round shape in white.

As mentioned above, the balloons 550 may sway in the wind. Beside or instead of the swaying motion, the balloons 550 may rotate like a balloon 580 as shown in FIG. 11D. The balloon 580 rotates around an axis 578 elongated vertically in the space. This enables the text shown in the front surface of the balloon 580 to gradually change, so that the user can view a longer text displayed on the surface of the balloon 580.

As an alternative embodiment, various modifications are available. In the above exemplary embodiment, the extract operation stars if the event detector 30 detects a user input. However, the extract operation may start without the user input. For example, if the number of the tabs 500 in the application windows 511 and 513, or the number of the application windows exceeds a threshold, the extract operation may start.

The balloons 550 may be displayed not to overlap each other. In such a modification, the balloons 550 may deform if the balloons 550 contact each other in the sway motion. The stiffness (degree of deformation) of the balloons 550 may vary depending on the attribute, e.g. the frequency of use of the corresponding one of the tabs 500. For example, one of the balloons 550 tied to a frequently used tab may be hard and not deform easily, while another one of the balloons 550 tied to a less frequently used tab may be soft and deform easily.

The balloons 550 may be compressed, in other words the size of the balloons 550 may decrease, if the barometric pressure in the 3D virtual space is high.

The balloons 550 may be transparent or translucent. This modification allows the user to read the text in an overlapped area of the balloons 550 even if the balloons 550 overlap each other.

In the above exemplary embodiment, the wind blows entirely in the 3D virtual space. Instead, the wind may blow in a specific part of the 3D virtual space. This enables the wind to blow toward some of the tabs 500 displayed in the 3D virtual space. In this case, some of the tabs 500 blown by the wind react to display the balloons 550 while the other tabs 500 out of the wind do not react to display the balloons 550.

In the above exemplary embodiment, each of the balloons 550 is uniquely connected and associated with each of the tabs 500. Instead, multiple balloons 550 may be tied to one of the tabs 500. Here, in the known window system, if the number of the tabs 500 in the application windows 511 and 513 increases, a collective tab, i.e. a grouping tab indicating multiple panels collectively may be shown in the right end of the tabs 500. In this case, multiple balloons 550 corresponding to the multiple panels may be displayed so as to be tied to the collective tab.

In the above exemplary embodiment, the balloons 550 may sway and rotate in the wind, but the movement (behavior) of the balloons is not limited thereto. For example, the balloons 550 may spin around as if being hit by a tornado. Alternatively, the balloons 550 may be in a static condition, that is to say the balloons 550 may stop in the 3D virtual space. In such a modification, the user may select a mode regarding the motion of the balloons 550 between a sway mode and a static mode.

In the above explanation referring to FIG. 9B, the preview panel 552 is shown to assist the user in selecting the balloon 551 or 553. Besides or instead of the preview panel 552, reading out the title of the corresponding panel by voice is applicable.

In the above explanation, various sets of the parameters have been described. Each set of the parameters may include a single parameter. For example, the parameters of the extraction may include a single parameter, e.g. the wind attribute.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Here, the present invention may be realized using all hardware or all software. It can also be realized using a combination of both hardware and software. The present invention may also be realized as a computer, data processing system, or computer program product. The computer program product may be stored and distributed on a non-transitory computer-readable medium. Here, the medium may be an electronic, magnetic, optical, electromagnetic, infrared, or semiconductor system (device or equipment), or a transmission medium. Examples of the non-transitory computer-readable medium include semiconductors, solid-state storage devices, magnetic tape, removable computer diskettes, random-access memory (RAM), read-only memory (ROM), rigid magnetic disks, and optical disks. Examples of optical disks at the present time include compact disk read-only memory (CD-ROM) disks, compact disk read/write (CD-R/W) disks, and DVDs.

The present invention has been explained above using an exemplary embodiment, but the technical scope of the present invention is not limited in any way by this exemplary embodiment. It should be clear to a person of skill in the art that various modifications and substitutions can be made without departing from the spirit and scope of the present invention.

What is claimed is:

1. An apparatus comprising:
a component controller configured to display a balloon component in a display area, the balloon component corresponding to a window component displayed in the display area, wherein the balloon component and the window component are selectable by a user; and
a dynamic controller configured to change a behavior of the balloon component on the basis of an environmental attribute.

2. The apparatus according to claim 1, wherein the environmental attribute comprises one attribute of a virtual space in the display area.

3. The apparatus according to claim 1, wherein the environmental attribute comprises an attribute of a virtual wind generated in the display area.

4. The apparatus according to claim 1, further comprising a switch configured to switch focus to window component on the basis of information about the balloon component.

5. The apparatus according to claim 1, wherein the balloon component shows identifying information to identify the window component.

6. The apparatus according to claim 1, further comprising a receiver receiving an input of the environmental attribute, wherein the dynamic controller displays the balloon component on the basis of the input received by the receiver.

7. The apparatus according to claim 6, further comprising an image controller configured to display an image in the display area, wherein the position of the image is based on the input received by the receiver.

8. The apparatus according to claim 1, wherein the dynamic controller controls the balloon component to change information shown in the balloon component.

9. The apparatus according to claim 1, wherein the component controller displays a plurality of the balloon components, and the dynamic controller moves the plurality of the balloon components to change a relative position of the plurality of the balloon components.

10. The apparatus according to claim 1, wherein the component controller displays a plurality of the balloon components, and the dynamic controller moves the plurality of the balloon components to overlap each other.

11. The apparatus according to claim 1, wherein the component controller displays a plurality of the balloon components, and the dynamic controller controls the plurality of the balloon components to change the information shown in the display area.

12. The apparatus according to claim 1, wherein the component controller displays a same image in the display area responsive to selection of the balloon component or the window component by the user.

13. The apparatus according to claim 1, wherein the component controller changes a size of the balloon component on the basis of a usage condition of the window component.
